(19) United States
(12) Patent Application Publication
(10) Pub. No.: US 2009/0273476 A1
(43) Pub. Date: Nov. 5, 2009

(54) Merchandise Securing Device Having a Recessed Closure

(76) Inventor: Georg Siegel, Bergkamen (DE)

Correspondence Address: COLLARD & ROE, P.C., 1077 NORTHERN BOULEVARD, ROSLYN, NY, 11576, US

(21) Appl. No.: 12/225,784

(22) PCT Filed: Mar. 29, 2007
(86) PCT No.: PCT/DE2007/000577

§ 371 Date: Nov. 3, 2008

(30) Foreign Application Priority Data
Mar. 30, 2006 (DE) 10 2006 015 199.2

(51) Int. Cl. G08B 13/14

(52) U.S. Cl. 340/572.9

(57) ABSTRACT

The invention relates to a merchandise securing device (1) comprising at least one merchandise securing element (4, 5, 15) and a closing mechanism (6) with a fastening element (8) that can be inserted into a clamping element (18, 19, 20) of the closing mechanism (6) similar to a needle. Such a merchandise securing device (1) is provided with a housing contour that is essentially flat in the attachment area (14) in which the merchandise securing device (1) is fixed to the merchandise. The merchandise securing device (1) comprises a recessed closing mechanism (6) while the at least one merchandise securing element (4, 5, 15) located in or on the merchandise securing device (1) uses acoustomagnetic (AM) technology and/or radio frequency (RF) technology and/or radio frequency identification (RFID) technology.

Nowadays, merchandise securing devices are frequently already attached to the merchandise to be marked during its production, so that these merchandise securing devices remain on the merchandise for a long time, for example even during the entire logistics chain from production to the sales location. For this reason, it is of great importance, because of this long period of attachment of the merchandise securing device to the merchandise, that the merchandise securing devices do not stress the goods mechanically, or not to an impermissible degree, and lead to dents, folds, or other stresses, or even damage to the merchandise.

The merchandise securing devices used nowadays are frequently attached to the merchandise by means of so-called ball closures, in which a needle-like attachment element is inserted into a holder element equipped with clamping elements, for example in the form of balls, and fixed in place with force fit by means of the clamping elements. In this connection, the needle-like attachment element is typically inserted through openings in the merchandise, and is equipped with a wide head for securing the attachment element to the merchandise. Such holder elements are generally configured to be projecting and round, and sit on a housing of the merchandise securing device, on the outside, in such a manner that the holder element is easily accessible for fixation on the merchandise.

It is a disadvantage of this configuration of the merchandise securing devices that in the case of textile goods, in particular, but also in the case of a plurality of other merchandise, great mechanical stress and deformation of the merchandise occurs in the region in which the ball closure lies against the merchandise, because of the arrangement of the ball closure and the housing configuration of the merchandise securing device. Deformation and damage to the merchandise around the projecting ball closure occurs, again and again, as the result of the effect of gravity on hanging merchandise, for example, or pressure stress on merchandise that lies packed; this can lead to the result that the merchandise can only be sold by granting a suitable discount, or cannot be sold at all any more.

Since very different merchandise securing systems using different detection technologies are used in different stores, it is frequently problematic for the manufacturer of the merchandise to be secured to assure merchandise securing devices using the required technology, in each instance, for the related merchandise, during so-called source securing, since a plurality of different merchandise securing devices must therefore be used in parallel, and assigned to the appropriate merchandise, in each instance. This results in high costs and logistical problems in the case of source securing.

It is therefore the task of the present invention to further develop a merchandise securing device of the type stated, in such a manner that in particular, the impairments of or damage to the merchandise as described above can no longer occur, i.e. are reduced to a degree that cannot be avoided, and that the merchandise securing devices can be used as universally as possible.

The invention proceeds from a merchandise securing device having at least one merchandise securing element and a closure device having an attachment element that can be inserted into a clamping element of the closure device, in needle-like manner. Such a merchandise securing device of the type stated is developed further in that the merchandise securing device has an outer housing shape that is configured in planar manner, essentially in the region where the merchandise securing device is fixed in place on the merchandise, and a closure device disposed in recessed manner, whereby the at least one merchandise securing element uses acousto-magnetic technology (AM technology) and/or radio frequency technology (RF technology) and/or radio frequency identification technology (RFID technology) in or on the merchandise securing device. Because of the configuration of the outer shape of the merchandise securing device, the merchandise lies essentially flat against the merchandise securing device, at least in the region of attachment to the merchandise securing device, and is therefore no longer stressed around the ball closure or the like, which is usually configured to project. The closure device itself can also be structured, with regard to its outer contours, in such a manner that it is configured to be planar in the region of the possible contact zone with the merchandise. It is also possible that the housing of the merchandise securing device covers the closure device essentially over its full area in the region of the possible contact zone with the merchandise, in level manner, and only has one access, for example a small, hole-like access, for insertion of the needle-like attachment element. In addition, manipulation protection of the merchandise securing device is increased by means of such an extensive coverage of the closure device by the housing of the merchandise securing device, since the closure itself is no longer directly open with regard to its method of functioning, and also, the necessary method for releasing the closure device is not easy for a thief to recognize. Furthermore, opening of such closure devices by means of magnetic openers, for example, can be made more difficult with regard to manipulations, in that conventional magnetic openers cannot be used, or can only be used in a specific manner, in order to come into the required effect relationship with the closure device. By placing at least one merchandise securing element that works either with acousto-magnetic technology (AM technology) or radio frequency technology (RF technology) or radio frequency identification technology (RFID technology), or even a plurality of such merchandise securing elements using different technologies, on or in the merchandise securing device at the same time, it is possible to configure a merchandise securing device that can be universally used even for different detection technologies used by the dealers, in each instance, which is equally well suited for and compatible with almost all types of merchandise, whether robust merchandise or light textiles, in which the weight of the merchandise securing device is of great importance for its ability to be used. Such a merchandise securing device can also be changed, if necessary, with regard to the detection technologies used, for example if different merchandise securing elements are fundamentally provided by the design of the merchandise securing device, and can be equipped as the customer wishes, in each instance. When more than one merchandise securing element is used in the merchandise securing device, it is also possible, for example, to dispose multiple detection devices in the detection region, for example at the exit from a store, thereby reducing the possibilities of manipulation of the merchandise securing device and improving the reliability of detection.

Furthermore, it is possible that individual or all of the merchandise securing elements, in each instance, can also be configured so that they cannot be deactivated. In this way, the manipulability of such merchandise securing elements is reduced, since simple detuning of the detection frequencies, for example, is made more difficult by means of preventing manipulations. If a merchandise securing element using RFID technology is used, in particular, the known advantages with regard to the additional inclusion of product-specific data, for example, exist, and can be expanded in that the data in the merchandise securing element using RFID technology can be compared with a barcode on the merchandise at the cash register, and therefore manipulations of the barcode can be discovered, since the data in the merchandise securing element using RFID technology are much more difficult to manipulate than in the case of pure merchandise identification systems such as barcodes.

It is advantageous if the merchandise securing element on the basis of RF technology has a coil arrangement in which multiple windings are disposed perpendicular and parallel to one another, in a so-called multi-layer coil. This has the advantage that excellent functioning of the merchandise securing element can be achieved in the smallest possible space, with an 8.2 MHz center frequency being reached, and a sufficiently great Q factor also being achieved. These requirements are necessary in order to be able to detect with sufficient reliability in the related detection devices such as RF gates and antennas. The necessary tuning of the center frequency with a possibly related merchandise securing element using AM technology and the closure device, which consists of metal, must be taken into consideration in this connection. Since detuning of the center frequency can occur due to these components of the merchandise securing device, compensation must take place by means of adaptation of a capacitor switched in parallel with the coil. In interplay with the other components of the merchandise securing device, the location of the coil in the lower housing section of the merchandise securing device is important, since detuning of the resonance frequency can occur if the coil, which typically consists of copper, is bent outside of its basic shape. For this reason, the coil is correspondingly fixed in place in the lower housing section of the merchandise securing device.

With regard to the configuration of a merchandise securing element on the basis of AM technology, it should be pointed out that for this purpose, merchandise securing elements according to DE 10 2006 002.225.4 A1 can be used, in which a metglass strip can be magnetized with two individual small but strong magnets, in such a manner that very good detection behavior results at the AM frequency. Reference to this older patent is hereby made to its full extent.

It is advantageous if the merchandise securing device has a conventional ball closure or the like as a closure device. Such simple ball closures are sufficiently known from the state of the art, and therefore do not need to be described in greater detail here, with regard to their structure and method of functioning.

It is also possible to design the closure as a disposable closure device that can only be used once and then automatically locks. Such a disposable closure device in the form of a ball closure is also already fundamentally known from DE 10 2005 062 414 A1 or PCT/EP2006/012386. In this connection, a locking device on the ball closure ensures that after activation of the ball closure after the needle-like attachment element is first pulled out, movable parts of the ball closure cannot move back into the non-activated starting position, and the ball closure permanently loses its clamping effect. In this connection, however, it is also possible that such a disposable ball closure, which has lost its function as described, can be unlocked again by means of a special device, not accessible to the public, and thereby can be used again after all.

It is of great importance with regard to manipulation security that the closure device can be configured with a strong-lock function. Such closure devices having a strong-lock function, in which releasing the closure device is typically possible only with magnetic openers having a magnetic field intensity of more than 9000 Gauss, prevent manipulators from manipulating the closure device with magnets they have secretly transported into a store, and releasing it from the merchandise in unauthorized manner. In the production of ball closures with a strong-lock function, particularly strong springs are typically provided in the ball closures.

In another embodiment, the merchandise securing device can be developed further in that the housing of the merchandise securing device has an accommodation, particularly a window-like accommodation, for flat data carriers such as price tags or the like. If such a flat data carrier is inserted into the window-like accommodation disposed, for example, on one of the outer surfaces of the housing of the merchandise securing device, for example an accommodation that is closed off on all sides, with the exception of one edge, and provided with a flat, open or transparent region surrounded by the edging, then the customer can read information concerning the price and possible discounts, for example, concerning merchandise properties, or other information, directly on the merchandise securing device, in clearly legible form, comprehensible to the customer. For the commercial user of such merchandise securing devices, the window-like accommodation offers the possibility of affixing easily replaceable data carriers concerning manufacturing data, barcodes, product identification data, or the like, directly to the merchandise securing device, and thereby using the merchandise securing device as a carrier medium for improving merchandise logistics, for example, even in advance of selling the merchandise.

It is furthermore possible that such data carriers can also be easily removed from the window-like accommodation and handed over to the customer during a payment procedure, for example, for payment at the cash register, or also for returns. In this way, the merchandise securing device simultaneously performs the function that previously had to be performed by additional price tags or labels. Also, the data carriers within the window-like accommodation can easily be replaced and supplemented, or also covered up, something that becomes necessary in the case of a price change, for example.

It is also possible, for example, to dispose merchandise securing elements using AM or RF technology, in addition or alternatively, on a merchandise securing device that accommodates a merchandise securing element using RFID technology within its housing, in such a manner that these merchandise securing elements using AM or RF technology, laminated in, for example, between planar layers of paperboard or plastics, as a thin card, are pushed into the window-like accommodation, and therefore make corresponding merchandise securing technologies available, temporarily or in addition. In this connection, the window-like accommodation serves as an additional accommodation space for merchandise securing elements that are typically configured in thin manner, which are not disposed in the interior of the merchandise securing device itself and therefore can be easily retrofitted by being accommodated in the window-like accommodation. It is advantageous, in this connection, that these merchandise securing elements using AM or RF technology can be hidden in very unnoticeable manner, for example behind a paperboard label containing price information, and that in this way, a further increase in the manipulation security of the merchandise securing device can be achieved, without great additional costs.

It is also possible, for example, that the window-like accommodation as a whole is releasably fixed in place on the housing, and therefore can be separated from the housing. In this way, the window-like accommodation, together with all the data carriers disposed in it, can be released from the merchandise securing device and given to a customer, for example, in its entirety, for making payment for the merchandise at the cash register, without the contents of the window-like accommodation having to be removed from it and possibly getting lost on the way to the cash register.

Another particular property of the merchandise securing device can be achieved in that data carriers laid into the window-like accommodation, or also the additional merchandise securing elements using AM or RF technology, can be secured within the window-like accommodation in that the needle-like attachment element of the merchandise securing device is inserted into the holder device within the housing, relative to the window-like accommodation, in such a manner that unauthorized removal of the data carriers or also of the additional merchandise securing elements using AM or RF technology is blocked by means of the needle-like attachment element. For this purpose, the needle-like attachment element can be disposed on the single open insertion side of the window-like accommodation, for example, in the insertion direction of the data carriers, in such a manner that the needle-like attachment element blocks this open insertion side of the window-like accommodation after the data carrier has been inserted, and the data carrier can no longer be pulled out from there, for example. In another embodiment, it is also possible that the needle-like attachment element passes through a prepared, perforated section of the data carrier itself, for example, when it is inserted into the holder device within the housing, and thereby also secures the data carrier to prevent it from being removed from the window-like accommodation in this way.

In a further embodiment, it is possible that a monitoring device is disposed in the merchandise securing device, and makes contact with alarm devices disposed in the surroundings of the merchandise securing device, by means of a wireless connection, if the merchandise securing device or parts of the merchandise securing device are exposed to heat or an open flame. Specifically in the case of manipulation attempts on conventional merchandise securing devices having conventional ball closures, parts of the housing, which typically consists of plastic, are frequently burned or softened, for example in dressing rooms that are not watched, using lighters or battery-operated soldering guns, in such a manner that functionally important parts of the closure can be removed, in order to subsequently be able to easily remove the merchandise securing device from the merchandise. If a monitoring device, using an electronic temperature detection device, for example, now recognizes that temperatures that can be assessed as a manipulation attempt, for example temperatures above 50° C., prevail in the region of the merchandise securing device, such a monitoring device can transmit a signal to an alarm device, and thereby draw the attention of sales personnel or security personnel to the manipulation attempt that is occurring, and, if applicable, also indicate the location of the manipulation attempt. For this purpose, the monitoring device can have an electronic device for producing a wireless connection with the alarm device, by way of which silent or audible alarms can be triggered at the alarm device.

In another embodiment of the merchandise securing device according to the invention, the device can be made more resistant to manipulations involving heat or an open flame, in that a protector element made of a non-metallic, heat-resistant material is disposed in the region of the closure device, in such a manner that in the case of a manipulation in the region of the closure device, by means of heat or an open flame, the protector element shields the closure device from the heat or the open flame, in improved manner. Such protector elements were previously known only made of metallic materials, for example small metal plates that were introduced into the housing of a merchandise securing device, and guaranteed corresponding shielding of the closure device. Such protector elements made of metallic materials are greatly disadvantageous in the case of the merchandise securing device present here, however, since they, just like the closure device, clearly worsen the method of action of the merchandise securing elements, and, in particular, the resonance frequency of an 8.2 MHz RF coil, and can actually make it impossible. For this reason, non-metallic heat-resistant materials such as mica, silicone, or the like should be introduced, for example, into an accommodation chamber, lying opposite the needle-like attachment means, below the closure element, so that they can form a heat shield and so that it is or becomes more difficult to melt the ball closure out of the housing of the merchandise securing device during manipulation attempts. It is possible, in this connection, that the protector element is formed by a disk-like or shell-like element that is disposed below the closure device. In this connection, the protector element can also be disposed on the housing of the merchandise securing device, or worked into the housing of the merchandise securing device, for example completely integrated into the lower plastic half-shell of the housing, as early as during the injection-molding process of the plastic. In this way, a larger area-covering region can be achieved than with a protector element integrated into the closure device.

It is furthermore possible that a dye ring is disposed on the needle-like attachment element, which surrounds the needle by 3600 in the region of the head of the attachment element. In this way, it can be assured, after the needle-like attachment element has been set on, that the needle-like attachment element cannot be manipulated without the risk of dye substance exiting from the dye ring, due to destruction of the dye ring. This additionally increases the security against manipulations of the merchandise securing device.

In another embodiment, it is advantageous if the housing is configured to be mechanically stable, to accommodate the at least one merchandise securing element. If, for example, a merchandise securing element using RFID technology is introduced into the merchandise securing device, the accommodation of such a merchandise securing element in a stable housing has the advantage that the merchandise securing element is very well protected against mechanical stresses. Since merchandise securing elements using RFID technology are quite susceptible to mechanical stresses caused by bending, flexing, or the like, a guarantee of functioning of the merchandise securing element using RFID technology can be achieved by means of accommodation in the stable housing that is able to withstand mechanical stress, even over multiple usage cycles, and thus a high level of reusability can be achieved, thereby clearly increasing the economic efficiency of the merchandise securing device. For example, three to five minimum usage cycles per year can be achieved in this way, at a minimum period of use of five years, without defects of the merchandise securing element, for example due to contact problems or problems in readability, which can otherwise occur during transport.

For this purpose, it is advantageous, in a further embodiment, if the housing is formed from a plastic material, preferably from the plastic ABS, since such a material is very stable mechanically, for one thing, and for another, it also allows corresponding resistance to mechanical manipulation attempts. Also, such a material is not sensitive to thermal stresses that can occur when merchandise securing devices according to the invention are affixed to articles of clothing, for example, which stresses act on the clothing, and therefore also on the merchandise securing device attached to the clothing, by means of thermally acting tunnel finishers for subsequent treatment of articles of clothing after production. The dwell time in the tunnel finisher typically amounts to between 10 and 30 seconds, at a temperature of greater than 150° C. The passage of articles of clothing through steam treatment devices, which can bring about not only a corresponding temperature but also a high level of moisture on the merchandise securing device, also brings about corresponding stresses for the merchandise securing device. Appropriate materials for this purpose, such as ABS, are also advantageous for this, since they are not sensitive to moisture.

Furthermore, it is possible that the housing of the merchandise securing device is sealed to prevent the penetration of moisture, preferably the housing halves that form the sheath of the merchandise securing device are welded to one another. In this way, the penetration of moisture in the steam treatment devices mentioned above, for example, but also from other moisture sources, into the interior of the merchandise securing device is precluded, and thus the function of the components disposed in the housing of the merchandise securing device is guaranteed, even under great moisture stress. In this connection, in a further embodiment, the region of the closure device and the region or the regions of the merchandise securing elements can be configured separate from one another, and be sealed, relative to one another, in fluid-tight manner, in each instance. As a result, moisture that has penetrated into the insertion channel of the closure device, which can never be avoided entirely, is kept away from the other components disposed in the housing of the merchandise securing device, and therefore cannot disrupt their function.

With regard to haptics, but also with regard to cleanliness of the surface of the merchandise securing device, in a further embodiment the housing of the merchandise securing device can have a surface structure that is not smooth, preferably an eroded surface structure. In this connection, uneven areas are worked (eroded) into the mold die for the production of the housing of the merchandise securing device, in targeted manner, and are then reflected in the material of the housing, which is injected into the mold die while it is hot, on the outside of the housing.

It is also advantageous with regard to quality assurance of the merchandise securing device according to the invention if an identification possibility for the point in time of production of the merchandise securing device, preferably a date clock, is visibly applied to the housing. In this way, each merchandise securing device can be precisely identified with regard to its production date, and any problems in production of the merchandise securing device can be traced back, or also, the age of the merchandise securing device can be clearly determined.

In an advantageous modification of the merchandise securing device according to the invention, it is possible that the housing has a through bore, through which flexible hanging devices, particularly wire cables or the like, can be passed with one end, to affix the merchandise securing device, and fixed in place, and which can be fixed in place on the merchandise securing device by means of the closure device at their other end. In this way, the merchandise securing device according to the invention can be modified for being affixed to so-called handle merchandise such as suitcases or the like, on which the merchandise securing device cannot be fixed in place using a needle-like attachment element. Thin steel cables used for this purpose can be fixed in place with a thickened end, for example, which does not fit through the bore in the housing, on the housing of the merchandise securing device, and fixed in place on the closure device with their other end, and thereby loop around a section of the merchandise to be secured, in loose but unreleasable manner.

It is particularly advantageous that the merchandise securing device can be configured to have a small volume and, in total, to be lightweight, for example the weight can be less than 15 g. In this way, the merchandise securing device does not put stress on thin textiles, for example, with its weight, and also cannot deform or damage them impermissibly. Thus, even when the merchandise securing device is disposed to hang on the merchandise, no impermissible stress for such thin textile-like merchandise can occur.

It is furthermore possible that the needle of the attachment element is entirely made from a non-rusting material, preferably from stainless steel. Such materials cannot be damaged at the surface by being inserted into the closure element multiple times, as is the case with needles of basic materials that tend to rust and are only superficially coated with a non-rusting layer, which are very common nowadays, in such a manner that the basic material of the needle, which is then exposed, starts to rust. As a result, particularly if moisture is added, merchandise provided with the merchandise securing device can become dirty, and therefore become unusable or unsellable.

It is furthermore advantageous if the head of the attachment element completely sheathes the needle in its end region that faces away from the closure device, and accommodates the needle within it, and furthermore if the underside of the head of the attachment element, which faces the closure device, is configured to be smooth. Many attachment elements that are commonly used do not have a solid material cross-section on the underside, but rather a honeycomb-shaped hollow cavity construction, in which textile residues or dirt can easily accumulate, and subsequently dirty merchandise provided with the merchandise securing device.

It is important with regard to use of the merchandise securing device if the needle-like attachment element can be inserted into the housing of the merchandise securing device in such a manner that the thorn-like end does not come to rest where it is freely accessible, for example comes to lie behind a wall of the housing, in covered manner, and therefore the customer cannot be injured by the thorn-like end of the attachment element that unintentionally exits from the closure, on the end side.

A particularly preferred embodiment of the merchandise securing device according to the invention is shown in the drawing.

This shows:

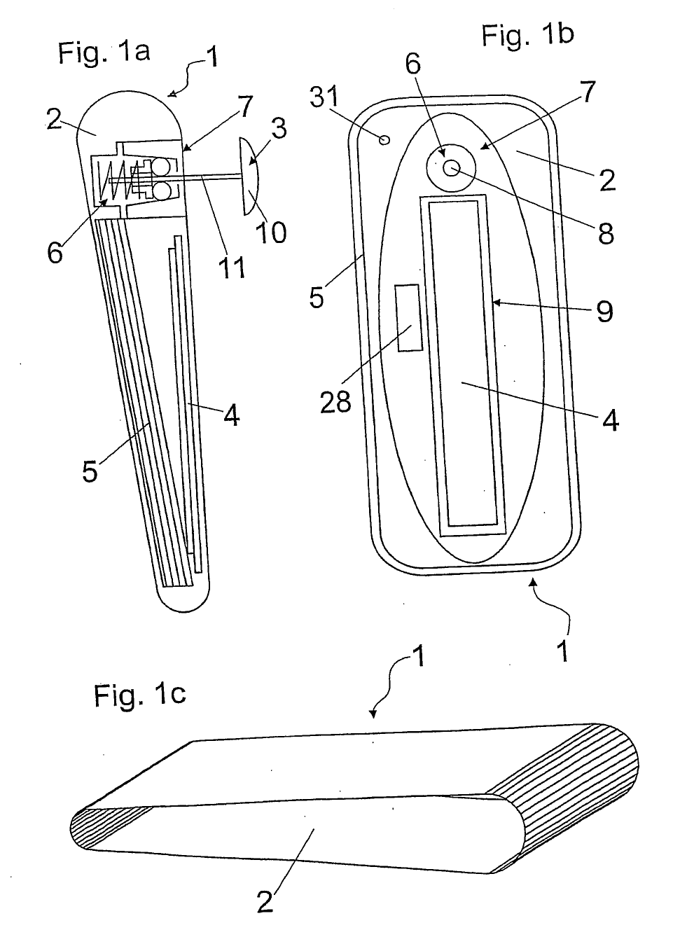

FIG. 1a-1c—a schematic representation of a first embodiment of the merchandise securing device according to the invention, having a ball closure disposed in covered manner, within a planar contact surface, for merchandise and AM as well as RF securing element,

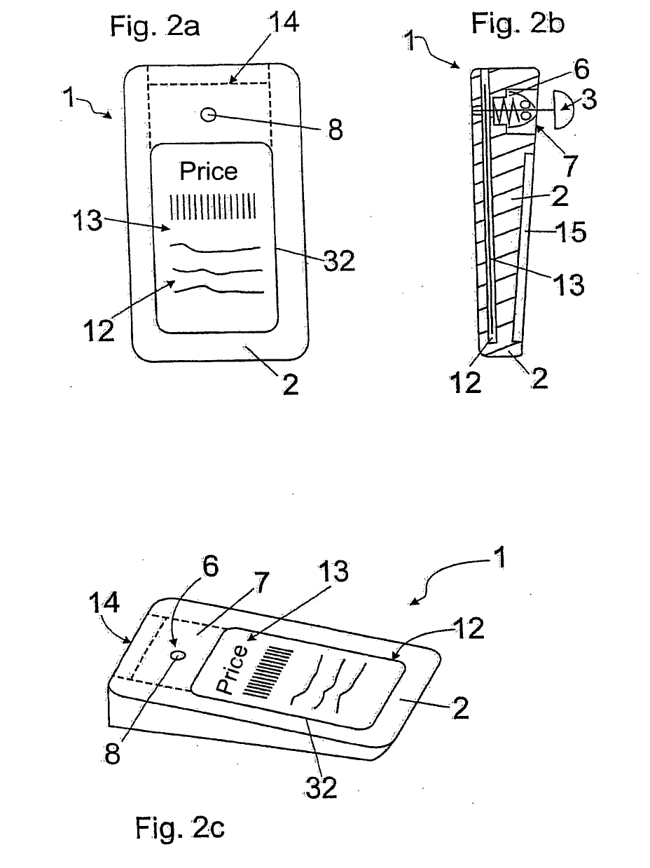

FIG. 2a-2c—another embodiment of the merchandise securing device according to the invention according to FIG. 1, having a window-like accommodation for data carriers or the like,

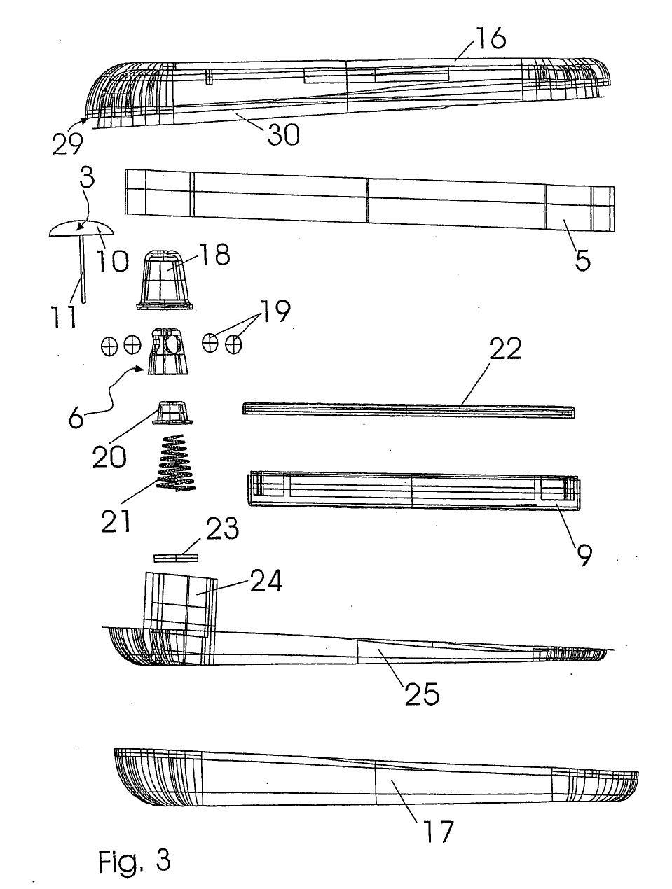

FIG. 3—an exploded representation of the merchandise securing device according to the invention according to FIG. 1,

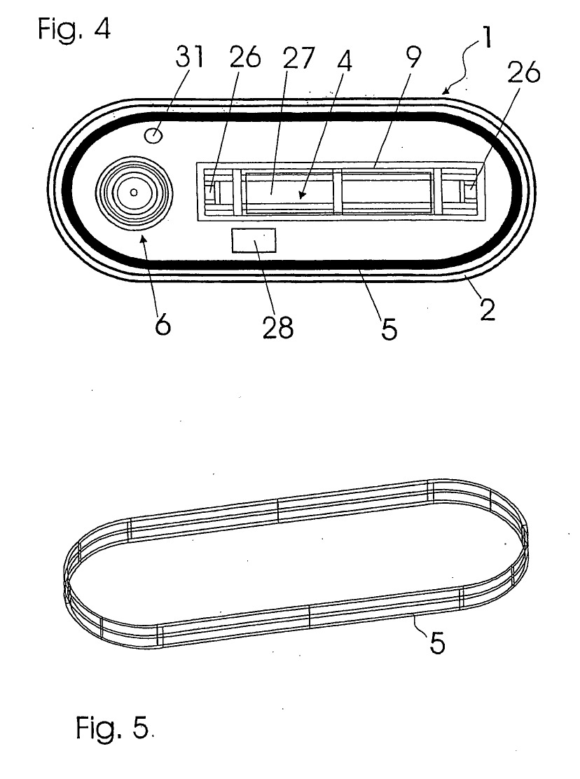

FIG. 4—a top view of the lower half of the merchandise securing device according to the invention according to FIG. 1,

FIG. 5—a spatial view of a coil of the RF securing element of the merchandise securing device according to the invention.

FIG. 1 shows the sectional side view (FIG. 1a), the sectional top (FIG. 1b), and the spatial side view (FIG. 1c) of a very schematic representation of the fundamental structure of the merchandise securing device 1 according to the invention, which can be seen in greater design detail once again in FIG. 3, in an exploded view of the major components of the merchandise securing device 1. In FIG. 4, a top view of the lower half shell 17 of the housing 2 of the merchandise securing device 1 can be seen, in which the components of the AM securing element are shown in greater detail, once again.

The merchandise securing device 1 consists of an essentially wedge-shaped housing 2 composed of two half-shells 16 and 17, between which all the essential components of the inner workings of the merchandise securing device 1 are completely accommodated. In this connection, the housing 2 essentially has an accommodation space 24 for a closure device in the form of a conventional ball closure 6 here, which is provided with a reinforced helical spring 21 for implementing a strong-lock function. The ball closure consists, in fundamentally known manner, of the helical spring 21, the ball bearing plate 20 for a number of balls 19 that rest against the closure cylinder 18 and wedge themselves against the needle 11 when the needle 11 of the needle-like attachment element 3 is inserted, and thereby hold it in place. Since such ball closures are comprehensively known, they will not be discussed further here.

Furthermore, at least one merchandise securing element 4, 5, 15 is accommodated in the housing 2, in a corresponding accommodation space, and serves, in fundamentally known manner, for detection of merchandise impermissibly taken along, at the exit from a store or the like, in that the merchandise securing device 1 interacts with detection devices disposed there. In this connection, it is possible that only one of the merchandise securing elements 4, 5, 15 mentioned above, two, or all of the merchandise securing elements at the same time are present on the merchandise securing device 1. Of course, other merchandise securing elements can also be added, which use other detection technologies. In this connection, the merchandise securing elements 4, 5, 15 are sufficiently known in terms of their fundamental structure, therefore the structure of these merchandise securing elements 4, 5, 15 will only be discussed here to the extent that this is important for their function in the merchandise securing device 1 according to the invention.

The merchandise securing element 5 according to RF technology consists essentially of a coil that is laid along the interior housing walls of the merchandise securing device 1, and, in this connection, is formed in this position by means of corresponding walls of the accommodation space 29 between the inner wall 30 and the upper housing shell 16. This coil 5, which is shown in perspective again in FIG. 5, as a separate component, has multiple coils perpendicular and parallel to one another, which are disposed in a so-called multi-layer coil. This has the advantage that an excellent function of the merchandise securing device 1 can be achieved, reaching the 8.2 MHz center frequency that is typical for RF technology, and also, a sufficiently great Q factor. These requirements are necessary in order to be able to detect in the related detection devices, such as RF gates and antennas, with sufficient reliability. The necessary tuning of the center frequency with a possibly related merchandise securing element 4 using AM technology and the closure device 6 that consists of metal must be taken into consideration in this connection. Since detuning in the center frequency can occur by means of these components of the merchandise securing device 1, compensation must take place by means of adaptation of a capacitor, not shown, that is switched in parallel with the coil 5. In interplay with the other components of the merchandise securing device 1, the location of the coil 5 in the lower housing shell 17 of the merchandise securing device 1 is important, since detuning of the resonance frequency also occurs if the coil 5, which typically consists of copper, is bent outside of its basic shape. For this reason, the coil 5 is fixed in place in the accommodation space 29 in the lower housing shell 17, accordingly, by means of the walls 30.

Also in the interior of the housing 2, a merchandise securing element 4 according to AM technology can be seen, in which a metglass strip 27 is accommodated in a housing 9 having a lid 22, so as to be capable of vibrating, whereby a magnet 26 is disposed in front of and behind the, in each instance, in an extension of the metglass strip 27, and forms a detection element by means of AM technology that is capable of vibrating and can be excited from the outside, together with the metglass strip 27. Such a configuration of a merchandise securing element 4 according to AM technology has already been described in detail in DE 10 2006 002 225.4 A1, and therefore reference is made to the disclosure there, to its full extent, at this point.

The accommodation of a merchandise securing element 15 according to RFID technology is only intended to be very roughly indicated; it is shown in FIG. 2, for example, in a further accommodation space in the housing 2. Such merchandise securing elements 15 according to RFID technology are also fundamentally known.

Also in the interior of the housing 2, a monitoring device 28 that is only indicated schematically can be seen; it makes contact with alarm devices, not shown, disposed in the surroundings of the merchandise securing device 1, by means of a wireless connection, if the merchandise securing device 1 or parts of the merchandise securing device 1 are exposed to heat or an open flame. Specifically in the case of manipulation attempts on conventional merchandise securing devices 1, parts of the housing 2, which typically consists of plastic, are frequently burned or softened, for example in dressing rooms that are not watched, in the case of conventional ball closures 6, using lighters or battery-operated soldering guns, in such a manner that functionally important parts of the closure device 6 can be removed, in order to subsequently be able to easily remove the merchandise securing device 1 from the merchandise. If a monitoring device 28, using an electronic temperature detection device, for example, now recognizes that temperatures that can be assessed as a manipulation attempt, for example temperatures above 50° C., prevail in the region of the merchandise securing device 1, such a monitoring device 1 can transmit a signal to an alarm device, and thereby draw the attention of sales personnel or security personnel, for example, to the manipulation attempt that is occurring, and, if applicable, also indicate the location of the manipulation attempt. For this purpose, the monitoring device 28 can have an electronic device for producing a wireless connection with the alarm device, by way of which silent or audible alarms can be triggered at the alarm device.

Another measure to prevent such manipulations by means of heat or an open flame, in the form of a protector element 23, can be seen in the figure. For this purpose, the protector element 23, made of a non-metallic, heat-resistant material, is disposed in the region of the closure device 6, in such a manner that in the case of a manipulation in the region of the closure device 6 by means of heat or an open flame, the protector element 23 shields the closure device 6 against the heat of the open flame, in improved manner. Such protector elements 23 were previously known only made of metallic materials, for example small metal plates that were introduced into the housing 2 of a merchandise securing device 1, and guaranteed corresponding shielding of the closure device 6. Such protector elements 23 made of metallic materials are greatly disadvantageous in the case of the merchandise securing device 1 present here, however, since they, just like the closure device 6, clearly worsen the method of action of the merchandise securing elements 4, 5, 15, and, in particular, the resonance frequency of an 8.2 MHz RF coil 5, and can actually make it impossible. For this reason, non-metallic heat-resistant materials such as mica, silicone, or the like should be introduced, for example, into an accommodation chamber, lying opposite the needle-like attachment means 3, below the closure element 6, so that they can form a heat shield and so that it is or becomes more difficult to melt the ball closure 6 out of the housing 2 of the merchandise securing device 1 during manipulation attempts.

Also only indicated only schematically in the figures is a pass-through opening 31 that extends through the housing 2, by means of which suitable flexible hanging devices, not shown, particularly wire cables or the like, can be passed through with one end, and fixed in place, and which can be fixed in place on the merchandise securing device 1 by means of the closure device 6 at their other end. In this way, the merchandise securing device 1 according to the invention can be modified for being affixed to so-called handle merchandise such as suitcases or the like, on which the merchandise securing device 1 cannot be fixed in place using a needle-like attachment element 3. Thin steel cables used for this purpose can be fixed in place with a thickened end, for example, which does not fit through the pass-through opening in the housing 2, on the housing 2 of the merchandise securing device 1, and fixed in place on the closure device 6 with their other end, and thereby loop around a section of the merchandise to be secured, in loose but unreleasable manner.

The housing shells 16, 17 are set onto one another after the corresponding functional elements have been laid in, and welded to one another in fluid-tight manner, so that in particular, the sections of the merchandise securing device 1 that are and must be accessible from the outside (the region of the closure device 6 and the pass-through opening 31 are separated from the regions of the housing that are not allowed to come into contact with water or the like, in fluid-tight manner.

By means of the configuration of the outer shape of the housing 2 of the merchandise securing device 1, the merchandise lies essentially flat against the merchandise securing device 1, at least in the region of the fixation 7 to the merchandise securing device 1, and is therefore no longer stressed around the ball closure device 6 or the like, which is otherwise usually configured to project. In this connection, the closure device 6 itself is also be configured, with regard to its outer contours, in such a manner that it is configured to be planar in the region of the possible contact zone 7 with the merchandise. Also, the housing 2 of the merchandise securing device 1 covers the closure device 6 essentially over its full area in the region of the possible contact zone 7 with the merchandise, in level manner, and only has one access, for example a small, hole-like access 8, for insertion of the needle-like attachment element 3. In addition, manipulation protection of the merchandise securing device 1 is increased by means of such an extensive coverage of the closure device 6 by the housing 2 of the merchandise securing device 1, since the closure device 6 itself is no longer directly open with regard to its method of functioning, and also, the necessary method for releasing the closure device 6 is not easy for a thief to recognize. By placing at least one merchandise securing element 4, 5, 15 that works either with acousto-magnetic technology (AM technology) or radio frequency technology (RF technology) or radio frequency identification technology (RFID technology), or even a plurality of such merchandise securing elements 4, 5, 15 using different technologies, on or in the merchandise securing device 1 at the same time, it is possible to configure a merchandise securing device 1 that can be universally used even for different detection technologies used by the dealers, in each instance, which is equally well suited for and compatible with almost all types of merchandise, regardless of whether this is robust merchandise or light textiles.

FIG. 2 shows a modification of the housing 2, in that the housing 2 of the merchandise securing device 1 has an accommodation 12, particularly a window-like one, for flat data carriers 13 such as price tags or the like. If such a flat data carrier 13 is inserted into the window-like accommodation 12 disposed, for example, on one of the outer surfaces of the housing 2, for example an accommodation that is closed off on all sides, with the exception of one edge 32, and provided with a flat, open or transparent region surrounded by the edges 32, then the customer can read information concerning the price and possible discounts, for example, concerning merchandise properties, or other information, directly on the merchandise securing device 1, in clearly legible form, comprehensible to the customer. For the commercial user of such merchandise securing devices 1, the window-like accommodation 12 offers the possibility of affixing easily replaceable data carriers 13 concerning manufacturing data, barcodes, product identification data, or the like, directly to the merchandise securing device 1, and thereby using the merchandise securing device 1 as a carrier medium for improving merchandise logistics, for example, even in advance of selling the merchandise. Such a data carrier 13 can also be easily removed from the window-like accommodation 12, and handed over to the customer during a payment procedure, for example, for payment at the cash register, or also for returns. Also, the data carriers 13 within the window-like accommodation 12 can easily be replaced and supplemented, or also covered up, something that becomes necessary in the case of a price change, for example.

It is also possible, for example, to dispose merchandise securing elements 4, 5 using AM or RF technology, additionally or alternatively, on a merchandise securing device 1 that accommodates a merchandise securing element 15 using RFID technology within its housing 1, in such a manner that these merchandise securing elements 4, 5 using AM or RF technology, laminated in, for example, between planar layers of paperboard or plastics, as a thin card, are pushed into the window-like accommodation 12, and therefore make corresponding merchandise securing technologies available, temporarily or in addition. In this connection, the window-like accommodation 12 serves as an additional accommodation space. It is advantageous, in this connection, that these merchandise securing elements 4, 5 using AM or RF technology can be hidden in very unnoticeable manner, for example behind a paperboard label containing price information, and that in this way, a further increase in the manipulation security of the merchandise securing device 1 can be achieved, without great additional costs.

Another particular property of the merchandise securing device 1 can be achieved in that the data carriers 13 laid into the window-like accommodation 12, or also the additional merchandise securing elements 4, 5 using AM or RF technology, can be secured within the window-like accommodation 12 in that the needle-like attachment element 3 is inserted into the closure device 6 within the housing 2, in such a manner that unauthorized removal of the data carriers 13 or also of the additional merchandise securing elements 4, 5 is blocked by means of the needle-like attachment element 3. For this purpose, as shown in FIG. 2b, the needle-like attachment element 3 can be disposed on the single open insertion side 14 of the window-like accommodation 12, for example, in the insertion direction of the data carriers 13, in such a manner that the needle-like attachment element 3 blocks this open insertion side 14 of the window-like accommodation 12 after insertion, and the data carrier 13 can no longer be pulled out from there, for example.

### REFERENCE NUMBER LIST

1—merchandise securing device
2—housing
3—needle-like attachment element
4—AM securing element
5—RF securing element
6—closure device
7—planar housing region cover
8—insertion opening closure device
9—housing AM securing element
10—head needle-like attachment element
11—needle needle-like attachment element
12—window-like accommodation
13—data carrier
14—insertion opening
15—RFID securing element
16—housing upper shell
17—housing lower shell
18—closure cylinder
19—balls
20—ball bearing plate
21—helical spring
22—lid housing AM securing element
23—protector element
24—accommodation space ball closure
25—interior accommodation
26—magnets
27—metglass strip
28—monitoring device
29—accommodation space RF securing element
30—inner wall
31—pass-through opening
32—edge

1: Merchandise securing device (1) having at least one merchandise securing element (4, 5, 15) and a closure device (6) having a needle-like attachment element (3) that can be inserted into a clamping element (18, 19, 20) of the closure device (6),
wherein
the merchandise securing device (1) has an outer housing shape that is configured in planar manner, essentially in the region of fixation (14) of the merchandise securing device (1) on the merchandise, as well as a closure device (6) disposed in recessed manner, whereby in or on the merchandise securing device (1) there are arranged at least two merchandise securing elements (4, 5, 15) which use acousto-magnetic technology (AM technology) and/or radio frequency technology (RF technology) and/or radio frequency identification technology (RFID technology) and are able to function at the same time, and additionally, the merchandise securing element (4) for the acousto-magnetic technology (AM technology) is arranged to be enclosed by the merchandise securing element (5) for the radio frequency identification technology (RF-technology).

2. (canceled)

3: Merchandise securing device (1) according to claim 1, wherein individual or all of the merchandise securing elements (4, 5, 15), in each instance, are configured so that they cannot be deactivated.

4: Merchandise securing device (1) according to claim 1, wherein a merchandise securing element (15) using RFID technology is disposed on or in a housing (2) of the merchandise securing device (1), which is intended to accommodate product-specific information.

5: Merchandise securing device (1) according to claim 1, wherein the merchandise securing element (5) on the basis of RF technology has a coil arrangement in which multiple windings are disposed perpendicular and parallel to one another, in a so-called multi-layer coil.

6: Merchandise securing device (1) according to claim 5, wherein the coil (5) stands in an electrically conductive connection with a parallel capacitor, by which unavoidable influences on the working frequency of the merchandise securing element (5) on the basis of RF technology, caused by other components, particularly metallic components, of the merchandise securing device (1) can be compensated.

7: Merchandise securing device (1) according to claim 1, wherein the merchandise securing device (1) has a conventional ball closure or the like as a closure device (6).

8: Merchandise securing device (1) according to claim 7, wherein the closure device (6) is configured as a disposable closure device.

9: Merchandise securing device (1) according to claim 1, wherein the closure device (6) is configured with a strong-lock function.

10: Merchandise securing device (1) according to claim 9, wherein release of the closure device (6) having a strong-lock function is only possible with magnetic openers having a magnetic field intensity of more than 9000 Gauss.

11: Merchandise securing device (1) according to claim 1, wherein the housing (2) of the merchandise securing device (1) has an accommodation (12), particularly a window-like accommodation, for flat data carriers (13) such as price tags or the like.

12: Merchandise securing device (1) according to claim 11, wherein the window-like accommodation (12) is disposed on one of the outer surfaces of the housing (2) of the merchandise securing device (1).

13: Merchandise securing device (1) according to claim 11, wherein the window-like accommodation (12) has an edging (32) that is closed off on all sides, with the exception of one edge (14), having a flat, open or transparent center region surrounded by the edging (32).

14: Merchandise securing device (1) according to claim 11, wherein in the window-like accommodation (12), information, preferably concerning the price, possible discounts, concerning merchandise properties, or other information, can be read by the customer in clearly legible form, comprehensible to the customer.

15: Merchandise securing device (1) according to claim 11, wherein in the window-like accommodation (12), in easily replaceable manner, at least one data carrier (13) concerning manufacturing data, barcodes, product identification data, or similar information can be affixed to the merchandise securing device (1).

16: Merchandise securing device (1) according to claim 11, wherein the data carrier (13) can be easily removed from the window-like accommodation (12) and handed over to the customer, preferably during a payment procedure, for payment at the cash register, or also for returns.

17: Merchandise securing device (1) according to claim 11, wherein the data carrier (13) within the window-like accommodation (12) can easily be replaced or supplemented or covered up.

18: Merchandise securing device (1) according to claim 11, wherein merchandise securing elements (4, 5) using AM or RF technology are disposed, additionally or alternatively, on a merchandise securing device (1) that accommodates a merchandise securing element (15) using RFID technology within its housing (2), in such a manner that these merchandise securing elements (4, 5) using AM or RF technology, preferably laminated in between planar layers of paperboard or plastics, as a thin card, can be pushed into the window-like accommodation (12).

19: Merchandise securing device (1) according to claim 18, wherein the merchandise securing elements (4, 5) using AM or RF technology are disposed in very unnoticeable manner, behind a label containing price information.

20: Merchandise securing device (1) according to claim 11, wherein the window-like accommodation (12) as a whole can be releasably affixed to the housing (2) and separated from the housing (2).

21: Merchandise securing device (1) according to claim 20, wherein the window-like accommodation (12) released from the housing (2), together with all the data carriers (13) disposed in it, can be handed over to a customer for payment at the cash register.

22: Merchandise securing device (1) according to claim 11, wherein the data carrier (13) laid into the window-like accommodation (12), or the additional merchandise securing elements (4, 5) using AM or RF technology, can be secured within the window-like accommodation (12) in that the needle-like attachment element (3) of the merchandise securing device (1) is inserted into the closure device (6) within the housing (2), relative to the window-like accommodation (12), in such a manner that unauthorized removal of the data carrier (13) or of the additional merchandise securing elements (4, 5) using AM or RF technology can be blocked by means of the needle-like attachment element (3).

23: Merchandise securing device (1) according to claim 22, wherein the needle-like attachment element (3) passes through a section, preferably a section of the data carrier (13) itself, when it is inserted into the closure device (6) within the housing (2), and thereby secures the data carrier to prevent it from being removed from the window-like accommodation (12) in this way.

24: Merchandise securing device (1) according to claim 11, wherein a monitoring device (28) is disposed in the merchandise securing device (1), and makes contact with alarm devices disposed in the surroundings of the merchandise securing device (1), by means of a wireless connection, if the merchandise securing device (1) or parts of the merchandise securing device (1) are exposed to heat or an open flame.

25: Merchandise securing device (1) according to claim 24, wherein the monitoring device (28) has an electronic temperature detection device, with which heat or an open flame to which the merchandise securing device (1) is exposed can be detected.

26: Merchandise securing device (1) according to claim 25, wherein if the temperature detection device detects that a limit temperature, preferably a temperature of 50° C., has been exceeded, on the merchandise securing device (1) or parts of the merchandise securing device (1), it transmits a signal to the alarm device.

27: Merchandise securing device (1) according to claim 24, wherein the monitoring device (28) has an electronic device for producing a wireless connection with the alarm device, by way of which silent or audible alarms can be triggered at the alarm device.

28: Merchandise securing device (1) according to claim 1, wherein a protector element (23) made of a non-metallic, heat-resistant material is disposed in the region of the closure device (6), in such a manner that in the case of a manipulation in the region of the closure device (6) or of the merchandise securing device 1, by means of heat or an open flame, the protector element (23) shields the closure device (6) from the heat or the open flame, in improved manner.

29: Merchandise securing device (1) according to claim 28, wherein the protector element (23) is formed from a disk-like or shell-like element made of mica, silicone, or the like, and disposed below the closure device (6), lying opposite the needle element (3).

30: Merchandise securing device (1) according to claim 28, wherein the protector element (23) is disposed on the housing (2) of the merchandise securing device (1), or worked into the housing (2) of the merchandise securing device (1).

31: Merchandise securing device (1) according to claim 1, wherein a dye ring is disposed on the needle-like attachment element (3), which surrounds the needle by 360° in the region of the head (10) of the attachment element (3).

32: Merchandise securing device (1) according to claim 1, wherein the housing (2) for accommodation of the at least one merchandise securing device (4, 5, 15) is configured in mechanically stable manner.

33: Merchandise securing device (1) according to claim 1, wherein the housing (2) is formed from a plastic material, preferably from the plastic ABS.

34: Merchandise securing device (1) according to claim 1, wherein the housing (2) has a surface structure that is not smooth, preferably an eroded surface structure.

35: Merchandise securing device (1) according to claim 1, wherein an identification possibility for the point in time of production of the merchandise securing device (1), preferably for a date clock, is visibly applied to the housing (2).

36: Merchandise securing device (1) according to claim 1, wherein the housing (2) is sealed to prevent penetration of moisture, preferably the housing halves (16, 17) are welded to one another.

37: Merchandise securing device (1) according to claim 36, wherein the region of the closure device (6) and the region or the regions of the merchandise securing elements (4, 5, 15) are configured separate from one another, and sealed relative to one another, in each instance, in fluid-tight manner.

38: Merchandise securing device (1) according to claim 1, wherein the housing (2) has a continuous pass-through opening (31), through which suitable flexible hanging devices, particularly wire cables or the like, can be passed, to affix the merchandise securing device (1), and fixed in place, and can be fixed in place on the merchandise securing device (1) by means of the closure device (6) at their other end.

39: Merchandise securing device (1) according to claim 1, wherein the merchandise securing device (1) is configured to have a small volume and, in total, to be lightweight, preferably having a weight of less than 15 g.

40: Merchandise securing device (1) according to claim 1, wherein the needle (11) of the attachment element (3) is produced from a non-rusting material, preferably from stainless steel.

41: Merchandise securing device (1) according to claim 1, wherein the head (10) of the attachment element (3) completely sheathes the needle (11) in its end region that faces away from the closure device (6), and accommodates the needle within it.

42: Merchandise securing device (1) according to claim 1, wherein the underside of the head (10) of the attachment element (3), which faces the closure device (6), is configured to be smooth.

43: Merchandise securing device (1) according to claim 1, wherein the needle-like attachment element (3) can be inserted into the housing (2) of the merchandise securing device (1) in such a manner that the needle-like end does not come to rest where it is freely accessible, preferably coming to lie behind a wall of the housing (2), in covered manner.
